(19) United States
(12) Patent Application Publication
(10) Pub. No.: US 2008/0247557 A1
(43) Pub. Date: Oct. 9, 2008

(54) Information Processing Apparatus and Program

(75) Inventors: Takashi Sudo, Fuchu-shi (JP); Kimio Miseki, Ome-shi (JP); Yuji Kawashima, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/045,457

(22) Filed: Mar. 10, 2008

(30) Foreign Application Priority Data
Apr. 6, 2007 (JP) 2007-100674

(51) Int. Cl. H04B 3/20

(52) U.S. Cl. 381/66

(57) ABSTRACT

According to one embodiment, a signal processing apparatus includes a speaker configured to output the received input signal on which a delay detection signal which has a frequency component of an inaudible frequency on a received input signal is superposed to an acoustic space, an extracting section configured to extract the delay detection signal from the sending input signal outputted from microphone configured to collect sound in the acoustic space a calculating section configured to calculate a delay time between the received input signal and an acoustic echo component contained in the sending input signal, a delay section configured to delay the received input signal by a time corresponding to the delay time and generate a delayed received input signal, and an echo suppression processing section configured to suppress the acoustic echo component contained in the sending input signal by use of the delayed received input signal.

### CROSS-REFERENCE TO RELATED APPLICATIONS

This application is based upon and claims the benefit of priority from Japanese Patent Application No. 2007-100674, filed Apr. 6, 2007, the entire contents of which are incorporated herein by reference.

### BACKGROUND

1. Field

One embodiment of the invention relates to an signal processing apparatus and a program, and more particularly, to a signal processing apparatus which suppresses an echo by means of a program.

2. Description of the Related Art

Various types of high-quality attaining processes for speech signals, for example, processes for suppressing signals other than telephone communication signals, that is, acoustic echoes when telephone communication is made by use of a telephone communication apparatus are known.

In order to suppress the acoustic echo, the technique for measuring the distance from the communication apparatus to an echo reflection source and suppressing an acoustic echo by use of a received input signal delayed according to the thus measured distance and a sending input signal is disclosed (Jpn. Pat. Appln. KOKAI Publication No. 2007-27959 ([0010], [0011])).

In recent years, due to the increased processing performance of personal computers, as well as an increase in the speed of communications, the voice telephone call service using VoIP (voice over internet protocol) on personal computers is increasing. In a communication apparatus such as a personal computer using a multitask system, the timing of access to a memory device is not constant, and a fluctuation in synchronization between the sending input signal and the received input signal occurs even in the same call. There occurs a problem that since an error occurs in the echo suppressing process due to the synchronization fluctuation, suppression of an acoustic echo in the sending output signal makes it difficult to generate a normal sound and makes jarring or unnecessary noise, and thus the quality of a speech signal is degraded.

In the above communication apparatus, it is necessary to provide a device to measure the distance from the apparatus to the echo reflection source. Since a general-purpose device such as a personal computer has no distance measuring device, it is difficult to apply the above technique to the personal computer. Further, even if a distance measuring device is provided thereon, the timing of access to the memory device cannot be kept constant, and therefore, suppression of the acoustic echo is difficult.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the schematic configuration of a personal computer used as an signal processing apparatus according to a first embodiment of this invention.

FIG. 2 is a block diagram showing the configuration of a signal processing section in the first embodiment.

FIG. 3 is a block diagram showing the configuration of a resource monitoring section shown in FIG. 2.

FIG. 4 is a block diagram showing the configuration of an echo suppression processing section shown in FIG. 2.

FIG. 5 is a diagram showing a delay detection signal generated from a delay detection signal output section shown in FIG. 2.

FIG. 6A and FIG. 6B are diagrams showing delay detection signals generated from the delay detection signal output section shown in FIG. 2.

FIG. 7 is a flowchart for illustrating the flow of a whole process in the signal processing section of FIG. 2.

FIG. 8 is a flowchart for illustrating the flow of a delay amount calculation process in the first embodiment.

FIG. 9 is a flowchart for illustrating the flow of an echo suppressing process in the echo suppression processing section in the first embodiment.

FIG. 10 is a block diagram showing the configuration of a signal processing section according to a second embodiment of this invention.

FIG. 11 is a block diagram showing the configuration of an echo suppression processing section shown in FIG. 10.

FIG. 12 is a flowchart for illustrating the flow of an echo suppressing process in the echo suppression processing section in the second embodiment.

FIG. 13 is a block diagram showing the configuration of a signal processing section according to a third embodiment of this invention.

FIG. 14 is a block diagram showing the configuration of an echo suppression processing section shown in FIG. 13.

FIG. 15 is a flowchart for illustrating the flow of an echo suppressing process in the echo suppression processing section in the third embodiment.

### DETAILED DESCRIPTION

Various embodiments according to the invention will be described hereinafter with reference to the accompanying drawings. In general, according to one embodiment of the invention, a signal processing apparatus comprises a superposition processing section configured to superpose the delay detection signal which has a frequency component of an inaudible frequency on a received input signal, a speaker configured to output the received input signal on which the delay detection signal is superposed to an acoustic space, a microphone configured to collect sound in the acoustic space and output a sending input signal, an extracting section configured to extract the delay detection signal from the sending input signal, a calculating section configured to calculate a delay time between the received input signal and an acoustic echo component contained in the sending input signal based on a delay detection signal output from the delay detection signal generating section and the extracted delay detection signal, a delay section configured to delay the received input signal by a time corresponding to the delay time and generate a delayed received input signal, and an echo suppression processing section configured to suppress the acoustic echo component contained in the sending input signal by use of the delayed received input signal.

### First Embodiment

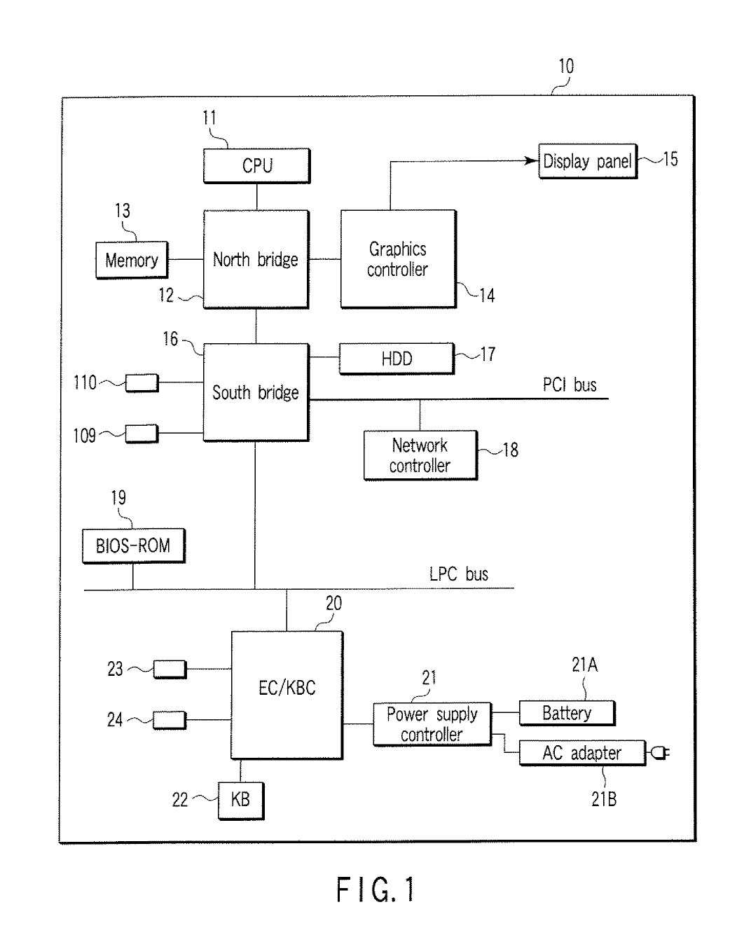

FIG. 1 is a block diagram showing the schematic configuration of a personal computer used as an signal processing apparatus according to a first embodiment of this invention.

As shown in FIG. 1, the present computer 10 includes a CPU 11, north bridge 12, main memory 13, graphics controller 14, display panel 15, south bridge 16, hard disk drive (HOD) 17, network controller 18, BIOS-ROM 19, embedded controller/keyboard controller IC (EC/KBC) 20, power supply controller 21 and the like.

The CPU 11 is a processor provided to control the operation of the present computer and executes an operating system (OS) and various application programs which are loaded from the hard disk drive (HDD) 17 into the main memory 13.

Further, the CPU 11 loads a BIOS (Basic Input Output System) stored in the BIOS-RON 19 into the main memory 13 and then executes the same. The system BIOS is a program for hardware control.

The north bridge 12 is a bridge device which connects the south bridge 16 to the local bus of the CPU 11. In the north bridge 12, a memory controller used to control access to the main memory 13 is also contained. The north bridge 12 further has a function of performing communications with respect to the graphics controller 14 via an AGP (Accelerated Graphics Port) bus or the like.

The south bridge 16 has a function of an audio controller including a function of converting a digital speech signal into an analog signal (D/A converter) and a function of converting an analog speech signal input from a microphone 110 into a digital signal (A/D converter). An analog signal converted by the D/A converter is output from a speaker 109.

The graphics controller 14 is a display controller which controls the display panel 15 used as a display monitor of the present computer. The graphics controller 14 has a video memory (VRAM) and generates a video signal used to form a display image to be displayed on the display panel 15 based on display data drawn on the video memory according to the OS/application program. A video signal generated by the graphics controller 14 is output to a line.

The embedded controller/keyboard controller IC (EC/KBC) 20 functions as a controller to control a keyboard 22, touch pad 23 and touch pad control button 24 used as input means. The embedded controller/keyboard controller IC 20 is a one-chip microcomputer which monitors and controls various devices (peripheral devices, sensors, power supply circuits and the like) irrespective of the system state of the present computer 10.

When external power is supplied via an AC adapter 21B, the power supply controller 21 generates system power to be supplied to the respective components of the present computer 10 by use of the external power supplied from the AC adapter 21B. Further, when external power is not supplied via the AC adapter 21B, the power supply controller 21 generates system power to be supplied to the respective components of the present computer 10 by use of a battery 21A.

The network controller 18 is a communication device which performs communications with an external network such as the Internet, for example.

Voice telephone call service is performed on the VoIP (voice over internet protocol) by use of the above personal computer. When the voice telephone call service is performed, the process of suppressing an echo component contained in the sending input signal is performed by the computer 10.

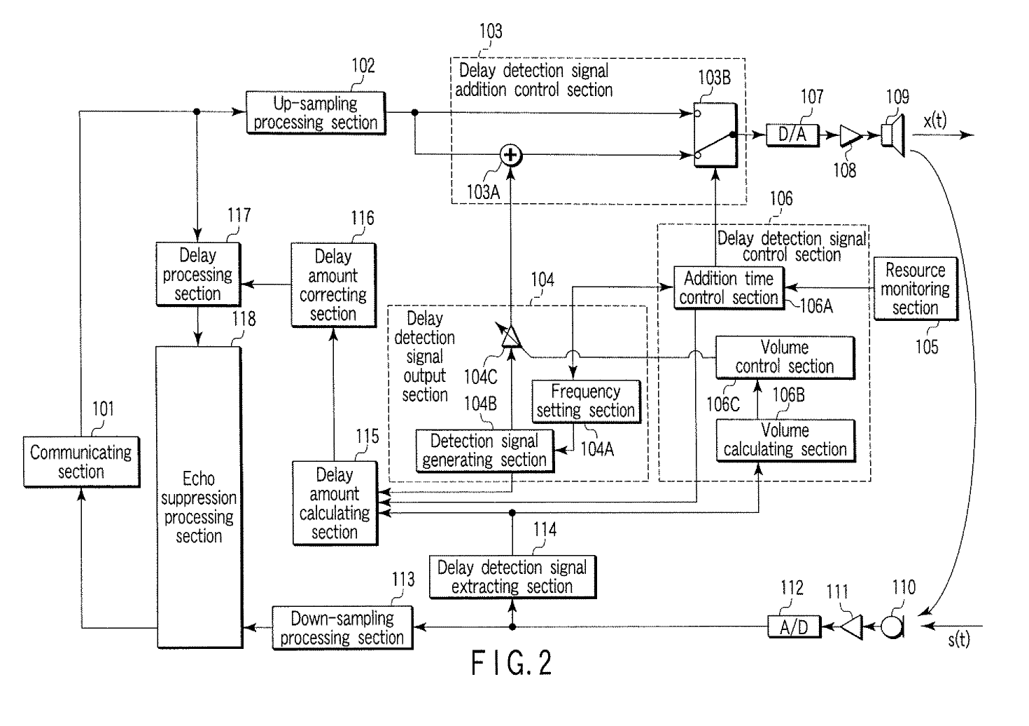

The configuration of the signal processing section which performs the voice telephone call service is explained with reference to FIGS. 2 to 4. FIG. 2 is a block diagram showing the configuration of the signal processing section in the first embodiment of this invention. The signal processing section includes a communicating section (received signal input section) 101, up-sampling processing section 102, signal addition control section 103, delay detection signal output section 104, resource monitoring section 105, delay detection signal control section 106, D/A converting section 107, received signal amplifier 108, speaker 109, microphone 110, sending signal amplifier 111, A/D converting section 112, down-sampling processing section 113, delay detection signal extracting section 114, delay amount calculating section 115, delay amount correcting section 116, delay processing section 117, echo suppression processing section 118 and the like.

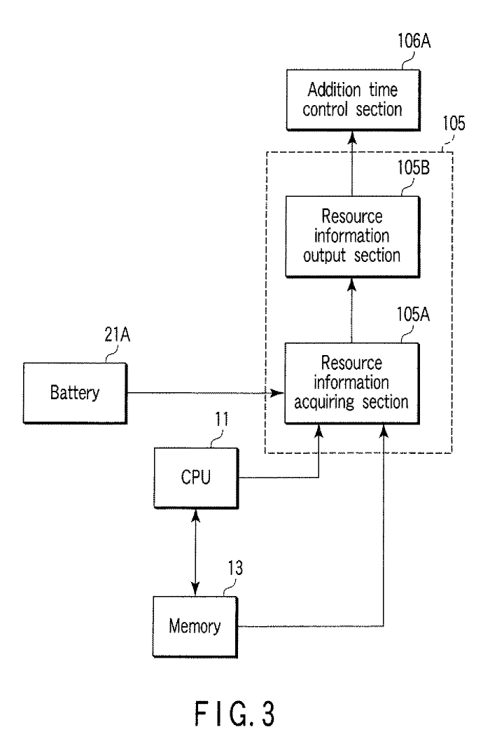

FIG. 3 is a block diagram showing the configuration of the resource monitoring section 105. The resource monitoring section 105 includes a resource information acquiring section 105A and resource information output section 105B.

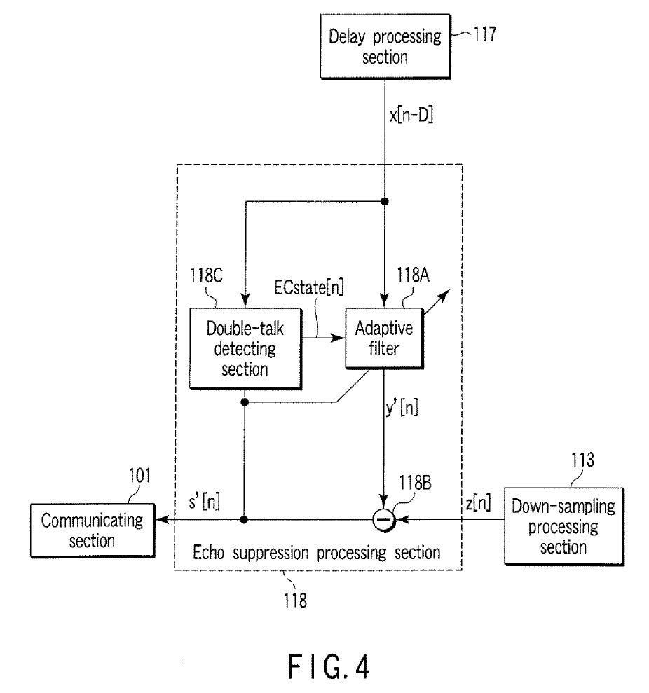

FIG. 4 is a block diagram showing the configuration of the echo suppression processing section 118. The echo suppression processing section 118 includes an adaptive filter 118A, signal subtraction processing section 118B and double-talk detecting section 118C.

The operations of the respective components of the signal processing section thus configured according to the first embodiment of this invention are explained with reference to FIGS. 2 to 4.

The communicating section 101 decodes data received from a remote terminal side (data of a sampling frequency (for example, 8 kHz) used in the echo suppression processing section 118) for each frame (for every N samples), which is the unit of the processing time previously determined, and outputs the decoding result to the up-sampling processing section 102 and delay processing section 117 as a received input signal x[n] (n=0, 1, . . . , N−1). The up-sampling processing section 102 up-samples the signal to a sampling frequency (for example, 48 kHz) of the D/A converting section 107 used for outputting a signal to an acoustic space and outputs the thus sampled signal to the signal addition control section 103.

The delay detection signal output section 104 includes a frequency setting section 104A, delay detection signal generating section 104B and signal amplifying section 104C. The frequency setting section 104A sets the frequency component of the delay detection signal to a frequency (for example, 22 kHz), which is a frequency of high-frequency band side (for example, no less than 20 kHz) of the inaudible frequency bands (for example, less than 10 Hz or no less than 20 kHz) and is not used by the echo suppression processing section 118, according to delay detection signal position information and a time pattern of one period of the delay detection signal output from an addition time control section 106A, which will be described later, and outputs the result to the delay detection signal generating section 104B. Further, the frequency setting section 104A outputs a frequency pattern of one period of the delay detection signal (a pattern of a frequency component of the delay detection signal in a time direction) to the addition time control section 106A.

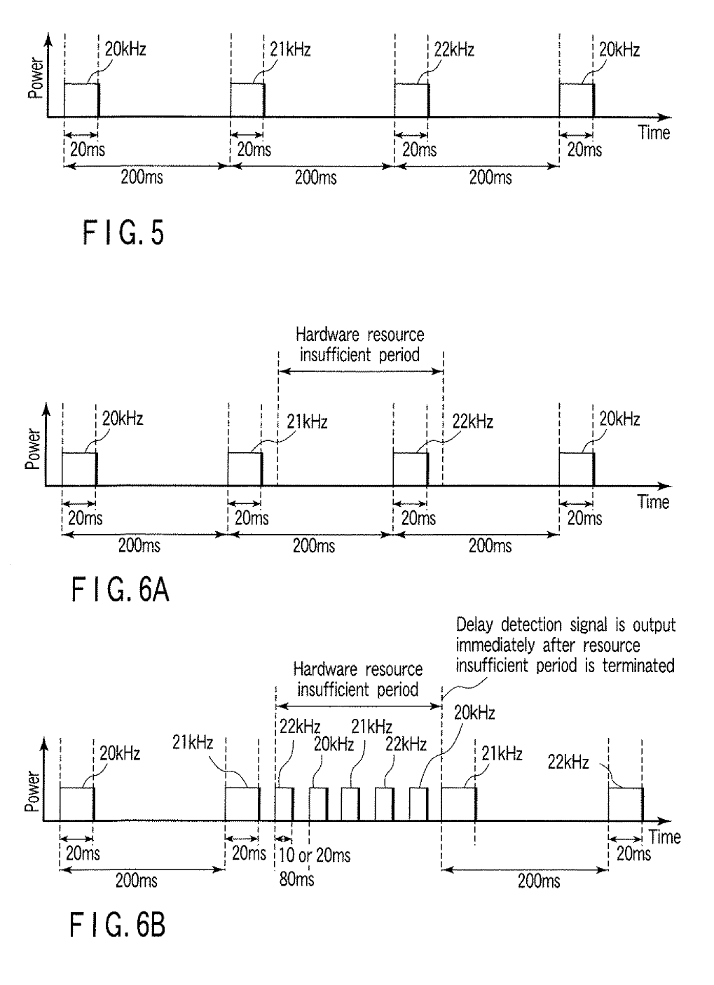

At this time, a delay amount over a long period of time between the received input signals x[n] and the echo components contained in the sending input signals z[n] can be detected by sequentially changing the frequency components of the delay detection signal set by the frequency setting section 104A to different frequency components as shown in FIG. 5. The delay detection signal may contain a plurality of frequency components. Further, the delay amount over a long period of time can be detected by sequentially changing each of the frequency components contained in the delay detection signal to a plurality of different frequency components.

The delay detection signal generating section 104B generates a signal of a set frequency band (for example, a sin-wave signal of 22 kHz) and outputs the same to the signal amplifying section 104C. The signal amplifying section 104C amplifies a delay detection signal g[n] according to volume information α output from a volume control section 106C and outputs α·g[n] to a signal adding section 103A.

The signal adding section 103A adds the amplified delay detection signal α·g[n] to the received input signal x[n]. A control switch 103B outputs a signal x[n]+α·g[n] obtained by adding the delay detection signal to the received input signal x[n] to the D/A converting section 107 according to addition time information output from the addition time control section 106A.

The resource monitoring section 105 monitors the hardware resources (the processing load of the CPU 11, the processing load of the memory 13, the remaining service life of the battery 21A) and outputs resource information indicating insufficiency of the resource to the addition time control section 106A.

For example, the resource information acquiring section 105A acquires resource information items of the CPU 11, memory 13 and battery 21A based on process management software such as a Windows task manager and transfers the same to the resource information output section 105B. Then, the resource information output section 105B outputs the resource information to the addition time control section 106A.

The addition time control section 106A has a time pattern of one period of the delay detection signal (time continuation length and intermission length) stored therein and sets the time continuation length and intermission length (time interval) during which the delay detection signal is added. The addition time control section 106A outputs the time pattern of one period of the delay detection signal set as addition time information to the control switch 103B to control the control switch 103B. Further, the addition time control section 106A outputs addition time information (the time pattern of one period of the delay detection signal) and delay detection signal position information indicating the position in one period of the delay detection signal in which the delay detection signal now output is set.

The addition time control section 106A sets a time interval (intermission length) during which the delay detection signal is added to an interval used as a frequency of low-frequency band side of the inaudible frequency bands (for example, less than 10 Hz or no less than 20 kHz). For example, as shown in FIG. 5, the time interval during which the delay detection signal is added is set to 200 ms (=5 Hz). By thus setting the time interval, a sound having the periodicity due to the time interval during which the delay detection signal is added can be prevented from being heard by the speaker in the nearby portion. Alternatively, the addition time control section 106A sets the time interval for addition to a random time interval using the maximal-length sequences so as to prevent the sound from being heard by the speaker in the nearby portion.

Further, the addition time control section 106A changes the time pattern of one period of the delay detection signal according to resource information output from the resource information output section 105B. For example, a frequency pattern/time pattern of one period of the delay detection signal, which is constant irrespective of the resource information, is shown in FIG. 6A. In this case, it is supposed that a time period in which the hardware resource becomes insufficient is provided as shown in FIG. 6A. In the above time period, a delay occurs in the access to the memory 13 and the timing of access to the memory 13 is not constant. Further, if the application frequency of the memory 13 becomes high, a process for increasing the space capacity is performed and the timing of access to the memory 13 becomes non-constant. Further, when the remaining service life of the battery is reduced, the operation frequency of the CPU 11 is automatically lowered to lower the processing speed and, as a result, a delay occurs in the access to the memory 13 and the timing of access to the memory 13 becomes non-constant. If the load of the CPU 11 is heavy, a delay tends to occur in the access to the memory 13 and the timing of access to the memory 13 becomes non-constant. In this state, delay amounts between the received input signals x[n] and the echo components contained in the sending input signals z[n] tend to fluctuate.

Therefore, as shown in FIG. 6B, the addition time control section 106A shortens the intermission length of the delay detection signal according to resource information of hardware when the resources are insufficient. Further, as shown in FIG. 6B, the addition time control section 106A performs the control operation to add the delay detection signal immediately after the resources are attained according to resource information of hardware and a resource insufficient period ends. By frequently adding the delay detection signal, the operation can be performed to rapidly follow the fluctuation in the delay amount caused by the resource insufficiency.

Further, the addition time control section 106A outputs delay detection signal position information indicating the position in one period of the delay detection signal in which the delay detection signal now output lies, a time pattern of one period of the delay detection signal and a frequency pattern output from the frequency setting section 104A as addition time frequency information to the delay amount calculating section 115.

The D/A converting section 107 converts a digital signal to an analog signal and outputs the analog signal to the received signal amplifier 108. The received signal amplifier 108 amplifies the analog signal and outputs the amplified signal as a received analog signal x(t) to the speaker 109. The speaker 109 outputs the received analog signal x(t) to an acoustic space.

The microphone 110 collects sounds in the acoustic space containing speech s(t) of the speaker in the nearby position and outputs the thus collected sound to the sending signal amplifier 111. At this time, not only the speech s(t) of the speaker in the nearby position but also acoustic echoes caused by a received analog signal x(t) was output to the acoustic space (echo path), and any noise are input. The sending signal amplifying section 111 amplifies the analog signal and outputs the amplified signal to the A/D converting section 112.

The A/D converting section 112 converts the amplified analog signal into a digital signal and outputs the thus converted digital signal to the down-sampling processing section 113 and delay detection signal extracting section 114 as a sending input signal z[n]. At this timer the A/D converting section 112 performs the converting operation by use of a sampling frequency (for example, 48 kHz) to be input from the acoustic space. In the down-sampling processing section 113, the signal is down-sampled from the sampling frequency of the A/D converting section 112 to the sampling frequency (for example, 8 kHz) used in the echo suppression processing section 118 and is then output to the echo suppression processing section 118.

The delay detection signal extracting section 114 extracts a high-frequency band containing a delay detection signal g[n] by use of an HPF (high-pass filter) (in time-domain) to extract the delay detection signal g[n] and outputs the thus extracted signal to a volume calculating section 106B and delay amount calculating section 115. The volume calculating section 106B calculates the power of a delay detection signal supplied through the echo path and outputs the calculated power to the volume control section 106C. The volume control section 106C determines that the amount of the delay detection signal supplied through the echo path is small when the power of the delay detection signal is low and supplies volume information to the signal amplifying section 104C so as to increase the volume of the delay detection signal. On the other hand, when the power of the delay detection signal is high, it determines that the amount of the delay detection signal supplied through the echo path is large and supplies volume information to the signal amplifying section 104C so as to reduce the volume of the delay detection signal. When the power of the delay detection signal is sufficient, it supplies volume information to the signal amplifying section 104C so as to maintain the volume of the delay detection signal.

The delay amount calculating section 115 calculates a delay amount by synchronizing the delay detection signal output from the delay detection signal generating section 104B in the past with the delay detection signal supplied through the echo path by use of the delay detection signal output from the delay detection signal generating section 104B in the past, addition time frequency information and delay detection signal supplied through the echo path and outputs the calculation result to the delay amount correcting section 116. Specifically, it calculates the frequency component of the delay detection signal supplied through the echo path by use of a BPF (band-pass filter) in time-domain or frequency-domain using such as FFT (Fast Fourier Transform) and calculates a difference between the present time and the time at which the delay detection signal containing the frequency component is output as a delay amount by use of the addition time frequency information. The thus calculated delay amount contains an error caused in the frequency calculation and an error in the continuation time length of the delay detection signal. Therefore, the cross-correlation between the delay detection signal output from the delay detection signal generating section 104B in the past and the delay detection signal supplied through the echo path is further calculated in the time domain only for a short period of time set by considering the calculated delay amount and the continuation time length of the delay detection signal so as to calculate a more precise delay amount.

The delay amount correcting section 116 subjects the delay amount to a rounding process to cope with the sampling frequency used in the echo process. Further, the delay amount is corrected by considering the process delay due to the filtering process in the delay detection signal extracting section 114. In addition, a difference between the delay in the frequency band used for the delay detection signal and the delay in the frequency band of the received input signal x[n] used in the echo process is previously stored. Then, a delay amount between the received input signal x[n] and the echo component contained in the sending input signal z[n] is calculated based on the delay amount of the delay detection signal by use of the above difference. By thus calculating the delay amount, since the speed of the delay detection signal in the high-frequency band supplied through the echo path becomes high in some cases when the directly input sound is not dominant due to the sound supplied through the echo path, the delay amount in the frequency band used in the echo process can be precisely calculated. The thus calculated delay amount between the received input signal x[n] and the echo component contained in the sending input signal z[n] is output as D to the delay processing section 117.

The delay processing section 117 delays the received input signal x[n] by the delay amount D and outputs the thus delayed signal to the echo suppression processing section 118. The echo suppression processing section 118 performs the process of suppressing the echo and outputs the resultant signal as a sending output signal s′[n] to the communicating section 101.

The communicating section 101 encodes the sending output signal s′[n] (n 0, 1, . . . , N−1) for each frame (for every N samples) and outputs the result to the remote terminal side.

The echo suppression processing section 118 receives the sending input signal z[n] output from the down-sampling processing section 113 and the delayed received input signal x[n-D] output from the delay processing section 117. Then, it suppresses the echo component in the sending input signal z[n] and outputs a signal obtained after the echo suppression process as a sending output signal s′[n] (n=0, 1, . . . , N−1). Further, it outputs double-talk information ECstate[n].

The adaptive filter 118A is an adaptive filter configured by a transversal filter having variable fitter coefficients h[i] (i=0, 1, . . . , L−1) of the length L.

The adaptive filter 118A receives the delayed received input signal x[n-D] output from the delay processing section 117, a residual signal e[n−1], which is a sending output signal output from the signal subtraction processing section 118B in the immediately preceding sampling cycle after the echo suppression process, and the double-talk information ECstate[n] output from the double-talk detecting section 118C. Then, it performs the adaptive learning process for the filter coefficients h[i] for each sample n when the double-talk information ECstate[n] does not indicate the double-talk state and does not perform the adaptive leaning process when the double-talk information ECstate[n] indicates the double-talk state.

Further, the adaptive filter 118A calculates and outputs an echo replica signal y′[n] (n=0, 1, . . . , N−1) by use of the delayed received input signal x[n-D] output from the delay processing section 117 and filter coefficients h[i].

The adaptive filter 118A performs the adaptive learning process by use of fixed or variable step sizes μ_{T}[n] (n=0, 1, . . . , N−1) used to control the updating width of the filter coefficients h[i].

Further, for example, the adaptive filter 118A is configured by an adaptive filter based on a linear adaptive algorithm such as the LMS (Least-Mean-Square) algorithm, NLMS (Normailized-Least-Mean-Square) algorithm, learning identification method, affine-projection (AP) algorithm or recursive-least-squares (RLS) algorithm or an adaptive filter based on a nonlinear adaptive algorithm such as a gradient-limited normalized-least-mean-square method or adaptive volterra filter. In the present embodiment, an example of a time-domain type adaptive filter is shown, but it can be configured by an adaptive filter used in a sub-band type (band division type)/frequency domain type.

The signal subtraction processing section 118B receives the sending input signal z[n] output from the down-sampling processing section 113 and the echo replica signal y′[n] output from the adaptive filter 118A. Then, it suppresses an echo component by subtracting the echo replica signal y′[n] from the sending input signal z[n] for each sample n and outputs a residual signal e[n], which is a signal obtained after the echo suppression. Further, it outputs the residual signal e[n] as sending output signals s′[n] (n=0, 1, . . . , N−1) to the communicating section 101.

The double-talk detecting section 118C receives the delayed received input signal x[n-D] output from the delay processing section 117 and the residual signal e[n−1], which is sending output signal output from the signal subtraction processing section 118B in the immediately preceding sampling cycle, and determines whether the double-talk state is set or not for each sample n.

Specifically, the double-talk detecting section 118C calculates a power characteristic (the power value or peak value: which is hereinafter referred to as a power characteristic) P_{Z}[n] (n=0, 1, . . . , N−1) of the sending input signal z[n], a power characteristic P_{X}[n] (n=0, 1, . . . , N−1) of the delayed received input signal x[n-D] and a power characteristic P_{E}[n] (n=0, 1, . . . , N−1) of the residual signal e[n] for each sample n. Then, it determines that the double-talk state is set when the relation of P_{E}[n]>λ[n]·P_{X}[n] or P_{Z}[n]>δ[n]·P_{X}[n] is set. In this case, λ[n] (n=0, 1, . . . , N−1) is an estimated value of an echo bus loss and is a variable value which is calculated for each sample n in which the filter coefficient h[i] (i=0, 1, . . . , L−1) is subjected to the adaptive learning process, becomes smaller as the adaptive learning process proceeds and becomes larger when the adaptive learning process is erroneously performed. Further, δ is a fixed value which can be previously set from the exterior before the operation is started. Then, the double-talk detecting section 118C outputs double-talk information ECstate[n] which is information indicating whether the double-talk state is set or not.

An echo suppression processing section 118 having no double-talk detecting section 118C can be used. In this case, the adaptive filter 118A performs the operation when the double-talk information ECstate[n] indicates that the double-talk state is not set.

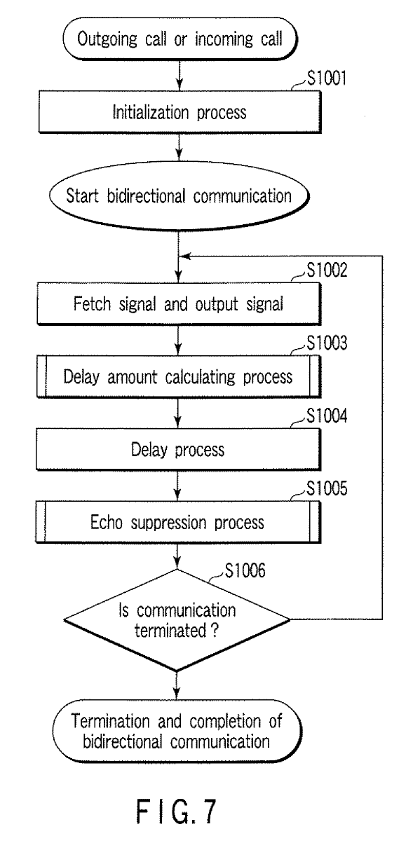

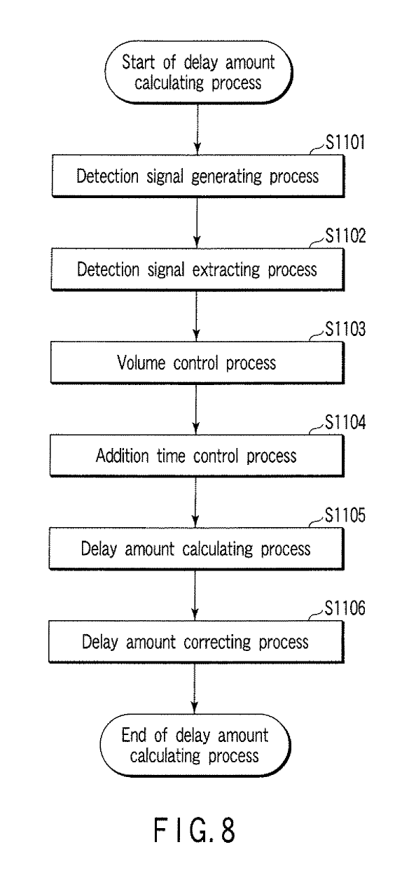

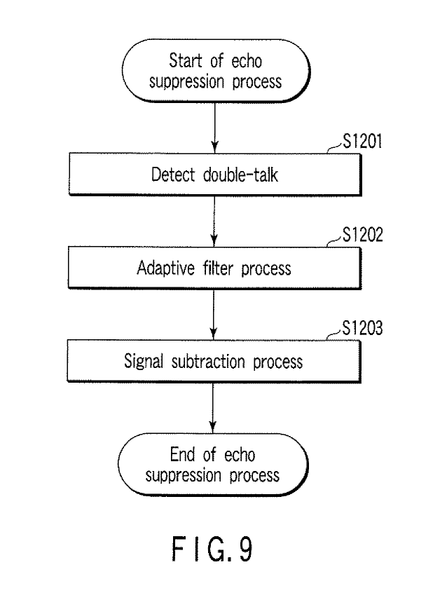

The flow of the process of the signal processing apparatus according to the first embodiment configured as described above is explained with reference to FIGS. 7 to 9. FIG. 7 is a flowchart for illustrating the flow of the whole process. FIG. 8 is a flowchart for illustrating the flow of the delay amount calculation process. FIG. 9 is a flowchart for illustrating the flow of the echo suppressing process in the echo suppression processing section 118.

In FIG. 7, when an outgoing call or incoming call occurs, the communicating section 101 performs a process of establishing a communication link and performs an initialization process such as initialization of each parameter and each buffer (step S1001). When a state in which bidirectional communication with a communication partner can be made is set by establishing the communication link and the bidirectional communication is started, a decoder (not shown) provided in the communicating section 101 fetches a signal decoded for each sample as a received input signal x[n]. Further, it fetches a sending input signal z[n] via the microphone 111 (step S1002).

Then, the delay amount calculating section 115 performs a process of detecting a delay amount (step S1003). The delay processing section 117 performs a process of temporarily storing the received input signal x[n] and delaying the same (step 31004). The echo suppression processing section 118 receives the delayed received input signal x[n-D] and sending input signal z[n] and performs the echo suppression process (step S1005). Then, the process from the step S1002 to the step S1005 is performed until the communication operation is terminated (step S1006).

The delay amount calculating process in the step S1003 is explained with reference to FIG. 8. First, the delay detection signal output section 104 generates an amplified delay detection signal α·g[n] (step S1101). The thus generated delay detection signal α·g[n] is added to the received input signal x[n] by the signal addition control section 103, output from the speaker 109 and input to the microphone 110 via an echo path.

Next, the delay detection signal extracting section 114 extracts a delay detection signal g[n] contained in the sending input signal z[n] collected by the microphone 110 (step S1102).

The volume calculating section 106B calculates the power of the delay detection signal g[n] extracted by the delay detection signal extracting section 114 and outputs the calculated power to the volume control section 106C. The volume control section 106C updates volume information α corresponding to the power of the delay detection signal and outputs the result to the signal amplifying section 104C (step S1103).

The addition time control section 106A determines the addition time of the delay detection signal g[n] according to resource information supplied from the resource monitoring section 105 and outputs addition time information to the frequency setting section 104A and control switch 103B. Further, the addition time control section 106A outputs delay detection signal position information to the frequency setting section 104A and outputs addition time frequency information to the delay amount calculating section 115 (step S1104)

The delay amount calculating section 115 calculates a delay amount by synchronizing the delay detection signal output in the past with the delay detection signal supplied through the echo path by use of the delay detection signal g[n] output in the past, addition time frequency information and delay detection signal g[n] supplied through the echo path (step S1105). The delay amount correcting section 116 corrects the delay amount (step S1106).

The echo suppression process in the step S1005 is explained with reference to FIG. 9. First, the double-talk detecting section 118C performs the double-talk detecting process (step S1201). Then, the adaptive filter 118A performs the adaptive filtering process to generate an echo replica under the control by the double-talk information ECstate[n] (step S1202). After this, the signal subtraction processing section 118B subtracts the echo replica signal y′[n] output from the adaptive filter 118A from the sending input signal z[n] (step S1203) and calculates and outputs a sending output signal s′[n], and then the echo suppression process is terminated.

As explained above, the delay amount between the received input signal and the echo component contained in the sending input signal is calculated by intermittently superposing the delay detection signal of a short period of time on the received input signal, extracting the components of the delay detection signal from the sending input signal and comparing the resultant signal with the delay detection signal before it is superposed on the received input signal. Then, the echo is suppressed based on the calculated delay amount so that a fluctuation (synchronization fluctuation) in the delay amount in the same call can be coped with. Since the frequency component of the delay detection signal is a signal of the frequency band which is not used in the echo suppression process and of an inaudible frequency band (a high-frequency band which cannot be heard) and is hardly influenced by the speech of the speaker in the nearby position, double-talk and noise, the estimation precision of the delay amount can be enhanced. Further, since it cannot be heard, the speaker will not feel unpleasant.

Such unpleasant feeling is caused by periodic sounds, caused due to the periodicity of the delay detection signal, and can be eliminated by setting the time interval (intermission length) in which the delay detection signal is output to the low inaudible frequency band. Further, the possibility that the user will be influenced by the Doppler effect caused by the movement of the user's head or ears, hears the delay detection signal and has an unpleasant feeling can be suppressed by intermittently outputting the delay detection signal for a short period of time.

In the present embodiment, the volume obtained by passing the delay detection signal to the sending input side through the echo path is calculated by the volume calculating section 106B and volume control section 106C. Then, even when the characteristic of the acoustic space, received amplifier 108 and sending signal amplifier 111 are changed by changing a volume added to the received input signal according to the calculated volume, the delay amount can be stably calculated and occurrence of an abnormal sound due to unexpected residual echoes in the echo suppression processing section 118 can be prevented.

The synchronization fluctuation due to insufficient hardware resources can be coped with and occurrence of an abnormal sound due to unexpected residual echoes in the echo suppression processing section 118 can be prevented by monitoring the hardware resources (the processing load of the processor, the processing load of the memory device, the remaining service life of the battery) by use of the resource monitoring section 105 and changing the timing at which the delay detection signal is output according to hardware resource information by use of the addition time control section 106A.

### Second Embodiment

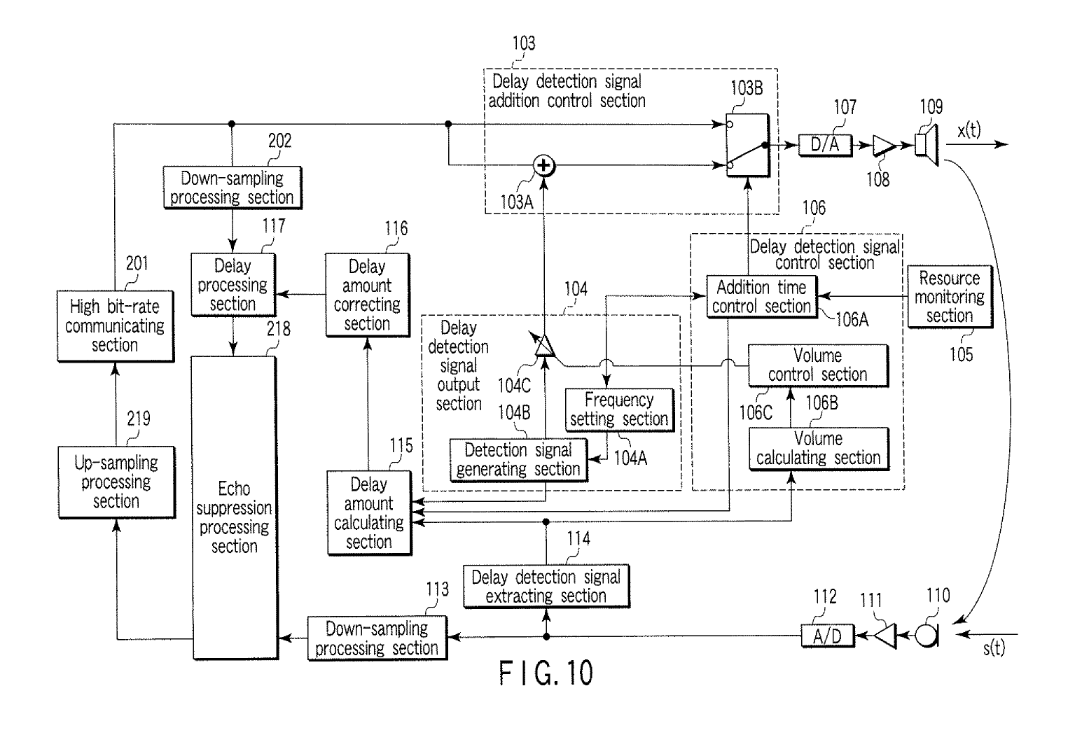

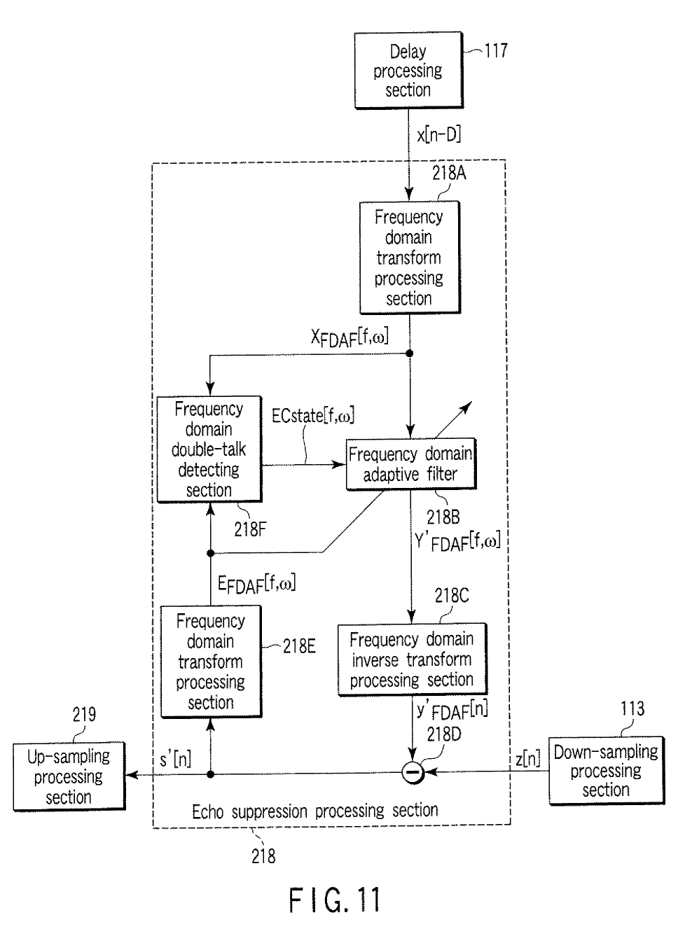

FIG. 10 is a block diagram showing the configuration of a signal processing section according to a second embodiment of this invention. Portions of the signal processing section which are different from the signal processing section of the first embodiment are explained below.

In the signal processing section, the sampling rates in the output path to the speaker 109 and in the input path from the microphone 110 are set at a higher sampling frequency in comparison with those in the signal processing section of the first embodiment.

For example, the sampling frequency of a received input signal x[n] output from a high bit-rate communicating section 201 and the sampling frequency of the A/D converting section 112 are both set at 48 kHz and the sampling frequency of data processed by the echo suppression processing section 118 is set at 16 kHz.

A down-sampling processing section 202 receives the received input signal x[n] output from the high bit-rate communicating section 201, converts the received input signal x[n] whose sampling frequency is 48 kHz into data whose sampling frequency is 16 kHz and outputs the thus converted data to the delay processing section 117.

An up-sampling processing section 219 receives a sending output signal s′[n] output from an echo suppression processing section 218. The up-sampling processing section 219 converts the sending output signal s′[n] whose sampling frequency is 16 kHz into a sending output signal whose sampling frequency is 48 kHz and outputs the thus converted signal to the high bit-rate communicating section 201.

Next, the configuration of the echo suppression processing section 218 of the signal processing section shown in FIG. 10 is explained with reference to FIG. 11. FIG. 11 is a block diagram showing the configuration of the echo suppression processing section 218 according to the second embodiment of this invention.

The echo suppression processing section 218 includes a frequency domain transform processing section 218A, frequency domain adaptive filter 218B, frequency domain inverse transform processing section 218C, signal subtraction processing section 218D, frequency domain transform processing section 218E and frequency domain double-talk detecting section 218F.

The echo suppression processing section 218 receives a sending input signal z[n] output from the down-sampling processing section 113 and a received input signal x[n-D] delayed by and output from the delay processing section 117. Then, it suppresses the echo component in the sending input signal z[n] and outputs a signal obtained after the echo suppression as a sending output signal s′[n] (n=0, 1, . . . , N−1) based on the overlap-save method or overlap-add method.

The frequency domain transform processing section 218A receives a delayed received input signal x[n-D] output from the delay processing section 117, transforms the received signal into a frequency domain by use of FFT (Fast Fourier Transform) and calculates and outputs a frequency spectrum X_{FDAF}[f, ω] of the received input signal. At this time, a windowing process using a Hamming window is performed, the past samples are used, and a zero-padding process is performed or an overlap process is performed based on the overlap-save method or overlap-add method. In this case, it is supposed that the frequency transform process is performed for each frame (for every N samples) and f denotes a frame number subjected to the frequency transform process. Further, ω denotes a frequency band obtained after the signal is transformed into the frequency domain.

The frequency domain adaptive filter 218B is configured by a transversal filter having a variable filter coefficient H_{FDAF}[f, ω]. Further, the frequency domain adaptive filter 218B receives the frequency spectrum X_{FDAF}[f, ω] of the received input signal output from the frequency domain transform processing section 218A, the frequency spectrum E_{FDAF}[f-1, ω] of the sending output signal in the immediately preceding frame output from the frequency domain transform processing section 218E and double-talk information ECₛₜₐₜₑ[f, ω] output from the frequency domain double-talk detecting section 218F. The frequency domain adaptive filter 218B subjects the filter coefficient H_{FDAF}[f, ω] to the adaptive learning process for each frame f and for each frequency band ω when the double-talk information ECₛₜₐₜₑ[f, ω] does not indicate the double-talk state. Further, it does not perform the adaptive learning process when the double-talk information ECₛₜₐₜₑ[f, ω] indicates the double-talk state. Thus, it calculates the filter coefficient H_{FDAF}[f, ω] and outputs the same to the frequency domain adaptive filter 218B. The frequency domain adaptive filter 218B calculates and outputs a frequency spectrum Y′_{FDAF}[f, ω] of an echo replica signal with Y′_{FDAF}[f, ω]=H_{FDAF}[f, ω]·X_{FDAF}[f, ω] by using the filter coefficient H_{FDAF}[f, ω] and frequency spectrum X_{FDAF}[f, ω] of the received input signal output from the frequency domain transform processing section 218A.

The frequency domain adaptive filter 218B performs the adaptive learning process by use of fixed or variable step size μ_{F}[f, ω] used to control the updating width of the filter coefficient H_{FDAF}[f, ω].

The frequency domain adaptive filter 218B determines a filter coefficient based on a linear adaptive algorithm such as the LMS (Least-Mean-Square) algorithm, NLMS (Normalized-Least-Mean-Square) algorithm, learning identification method, affine-projection (AP) algorithm or recursive-least-squares (RLS) algorithm or a non-linear adaptive algorithm such as a gradient-limited normalized-least-mean-square method or adaptive volterra filter. Further, in the present embodiment, an example of a gradient unconstrained frequency domain adaptive filter is shown, but a gradient constrained frequency domain adaptive filter can be used.

The frequency domain inverse transform processing section 218C receives the frequency spectrum Y′_{FDAF}[f, ω] of the echo replica signal output from the frequency domain adaptive filter 218B, calculates a echo replica signal y′_{FDAF}[n] (n=0, 1, . . . , N−1) by IFFT (Inverse Fast Fourier Transform) or the like and outputs the thus calculated signal to the frequency domain inverse transform processing section 218C. At this timer a process of using the past samples or a process of restoring the zero-padded or overlapped state into the original state is performed based on the overlap-save method or overlap-add method.

The signal subtraction processing section 218D receives the sending input signal z[n] output from the down-sampling processing section 113 and the echo replica signal y′_{FDAF}[n] output from the frequency domain inverse transform processing section 218C. Then, it subtracts the echo replica signal y′_{FDAF}[n] from the sending input signal z[n] for each sample n, suppresses the echo component and outputs a residual signal e[n], which is a signal obtained after the echo suppression, as a sending output signal s′[n].

The frequency domain transform processing section 218E receives the sending output signal s′[n] (residual signal e[n]) of a time-domain output from the signal subtraction processing section 218D, transforms the received signal into the frequency domain by FFT (Fast Fourier Transform) or the like and calculates and outputs a frequency spectrum E_{FDAF}[f, ω] of the sending output signal. At this time, a windowing process using a Hamming window is performed, the past samples are used, and a zero-padding process is performed or an overlap process is performed based on the overlap-save method or overlap-add method.

The frequency domain double-talk detecting section 218F receives the frequency spectrum X_{FDAF}[f, ω] of the received input signal output from the frequency domain transform processing section 218A and the frequency spectrum E_{FDAF}[f-1, ω] of the sending output signal output in an immediately preceding frame from the frequency domain transform processing section 218E. Then, it determines whether the double-talk state is set or not for each frame f and for each frequency band ω and calculates double-talk information ECₛₜₐₜₑ[f, ω], which is information indicating whether the double-talk state is set or not. The double-talk information ECₛₜₐₜₑ[f, ω] is output to the frequency domain adaptive filter 218B.

Specifically, the frequency domain double-talk detecting section 218F calculates the power spectrum |X_{FDAF}[f, ω]|² of the received input signal based on the frequency spectrum X_{FDAF}[f, ω] of the received input signal and power spectrum |E_{FDAF}[f-1, w]|² of the sending output signal based on the frequency spectrum E_{FDAF}[f, ω] of the sending output signal of the immediately preceding frame for each frame f and for each frequency band ω. Then, the frequency domain double-talk detecting section 218F determines that the double-talk state is set when the expression of |E_{FDAF}[f-1, ω]|²>λ_{FDAF}[f, ω]×|X_{FDAF}[f, ω]|² is established. In this case, λ_{FDAF}[f, ω] is an estimated value of an echo bus loss and is a variable amount which becomes smaller as the adaptive learning process for the filter coefficient H_{FDAF}[f, ω] proceeds and becomes larger as the adaptive learning process is erroneously performed. Further, λ_{FDAF}[f, ω] is updated and calculated for each frame f and for each frequency band ω obtained by subjecting the filter coefficient H_{FDAF}[f, ω] to the adaptive learning process. If the above expression is not established, the frequency domain double-talk detecting section 218F determines that the double-talk state is not set.

Of course, an echo suppression processing section 218 which does not include the frequency domain transform processing section 218A can be used. In this case, the frequency domain adaptive filter 218B performs the operation when the frequency domain double-talk information ECₛₜₐₜₑ[f, ω] indicates that the double-talk state is not set.

Since the flow of the whole operation of the signal processing section shown in FIG. 10 is the same as the flow explained in the flowchart of FIG. 7, the explanation thereof is omitted. Further, since the flow of the delay amount calculating process is also the same as the flow explained in the flowchart of FIG. 8, the explanation thereof is omitted.

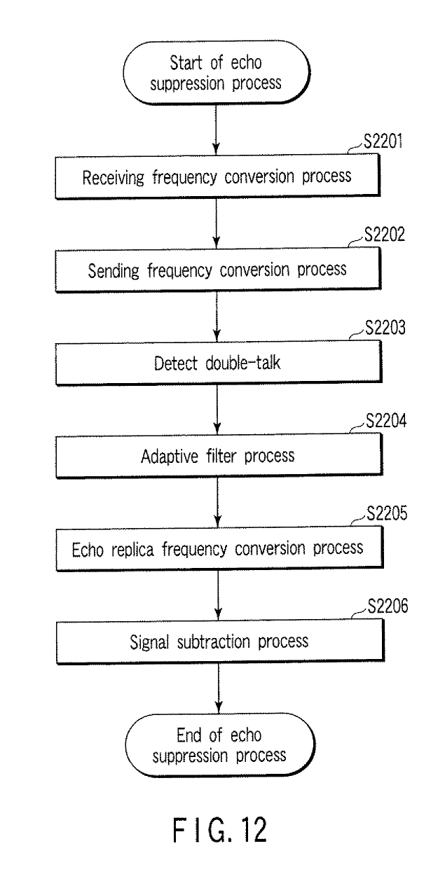

The flow of the process of the echo suppression processing section 218 shown in FIG. 11 is explained with reference to the flowchart of FIG. 12. The process of the echo suppression processing section 218 is performed as follows. First, the echo suppression processing section 218 transforms the received input signal x[n-D] into a frequency domain and calculates the frequency spectrum X_{FDAF}[f, ω] of the received input signal (step 52201). Then, the echo suppression processing section 218 transforms the sending output signal s′[n] into a frequency domain and calculates the frequency spectrum E_{FDAF}[f, ω] of the sending output signal (step S2202).

Next, the frequency domain double-talk detecting section 218F performs the frequency domain double-talk detecting process by use of the frequency spectrum X_{FDAF}[f, ω] of the received input signal and the frequency spectrum E_{FDAF}[f-1, ω] of the sending output signal of the immediately preceding frame (step S2203).

After this, the frequency domain adaptive filter 218B performs the frequency domain adaptive filtering process by use of the frequency spectrum X_{FDAF}[f, ω] of the received input signal and the frequency spectrum E_{FDAF}[f-1, ω] of the sending output signal of the immediately preceding frame under the control by the double-talk information ECₛₜₐₜₑ[f, ω] to generate a frequency spectrum Y′_{FDAF}[f, ω] of an echo replica signal (step S2204).

Next, the frequency domain inverse transform processing section 218C subjects the frequency spectrum Y′_{FDAF}[f, ω] of the echo replica signal to a frequency domain inverse transform process and calculates an echo replica signal y′_{FDAF}[n] (step S2205). Then, the signal subtraction processing section 218D subtracts the echo replica signal y′_{FDAF}[n] output from the frequency domain inverse transform processing section 218C from the sending input signal z[n] (step S2206), calculates and outputs a sending output signal s′[n] and thus the echo canceller process is terminated.

### Third Embodiment

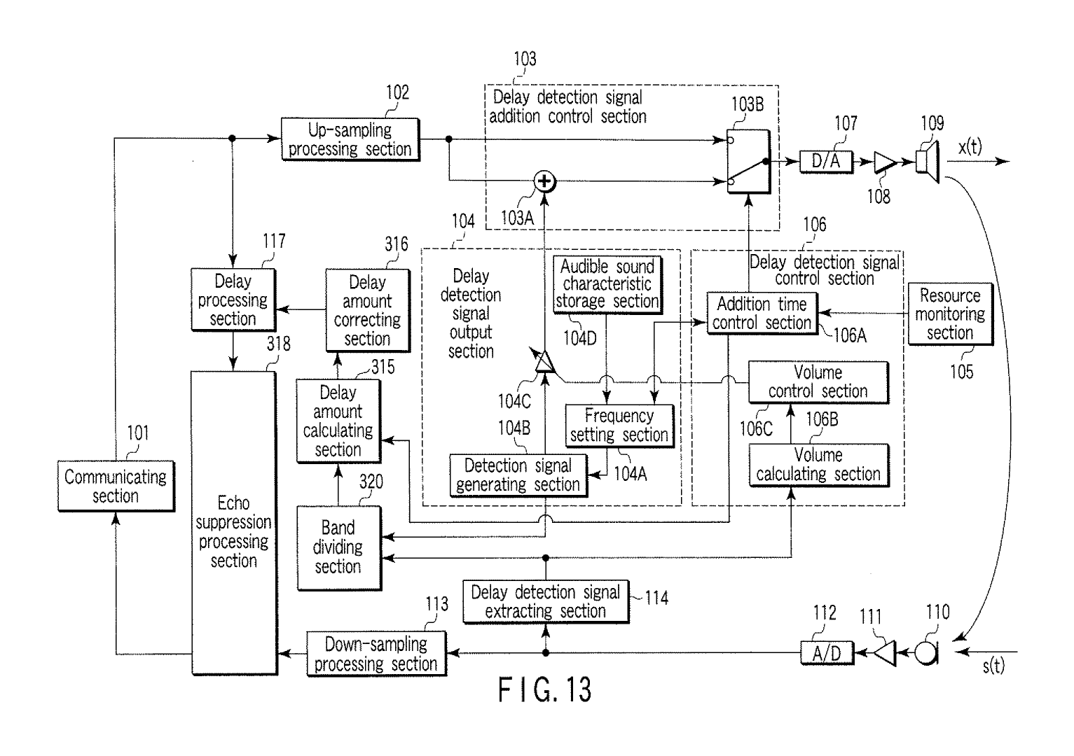

FIG. 13 is a block diagram showing the configuration of a signal processing section according to a third embodiment of this invention. Portions of the signal processing section which are different from the signal processing section of the first embodiment are explained below.

An audible sound characteristic storage section 104D which previously stores the upper limit of the audible frequency band based on the age of the user is provided. For example, the audible sound characteristic storage section 104D is supplied with the age of the user from a storage section (not shown) which stores the profile of the user. When the user gets older, the lower limit of the audible frequency band is not changed so much, but the upper limit is changed and it becomes difficult for the user to hear sounds of a high-frequency band. Therefore, the frequency band of the upper limit of the audible frequency band is stored according to the audible sound characteristic of the ages in the audible sound characteristic storage section 104D, that is, the upper limit of the audible frequency bands are stored. Examples of the upper limits of the audible frequency bands according to the ages are shown below.

15 years old: 22 kHz

20 years old: 20 kHz

30 years old: 17 kHz

40 years old: 15 kHz

The audible sound characteristic storage section 104D outputs the frequency band of the upper limit of the audible frequency bands to a frequency setting section 104A. Then, the frequency setting section 104A sets the frequency component of a delay detection signal to a frequency band which is a frequency band of the inaudible frequency bands and is not used in an echo suppression processing section 118, and is more than the output frequency band of the upper limit of the audible frequency bands.

Further, in the signal processing section shown in FIG. 13, a band dividing section 320 extracts a high-frequency component from the extracted delay detection signal or a delay detection signal supplied through an echo path by use of a filter bank such as a QMF (quadrature mirror filter). Further, it down-samples the signal and converts the same to a lower sampling frequency to coincide with the sampling frequency used in an echo suppression processing section 318. A delay amount calculating section 315 calculates a delay amount by use of the signal of the low sampling frequency which holds the original high-frequency component. In a delay amount correcting section 316, the process of rounding the delay amount is not performed.

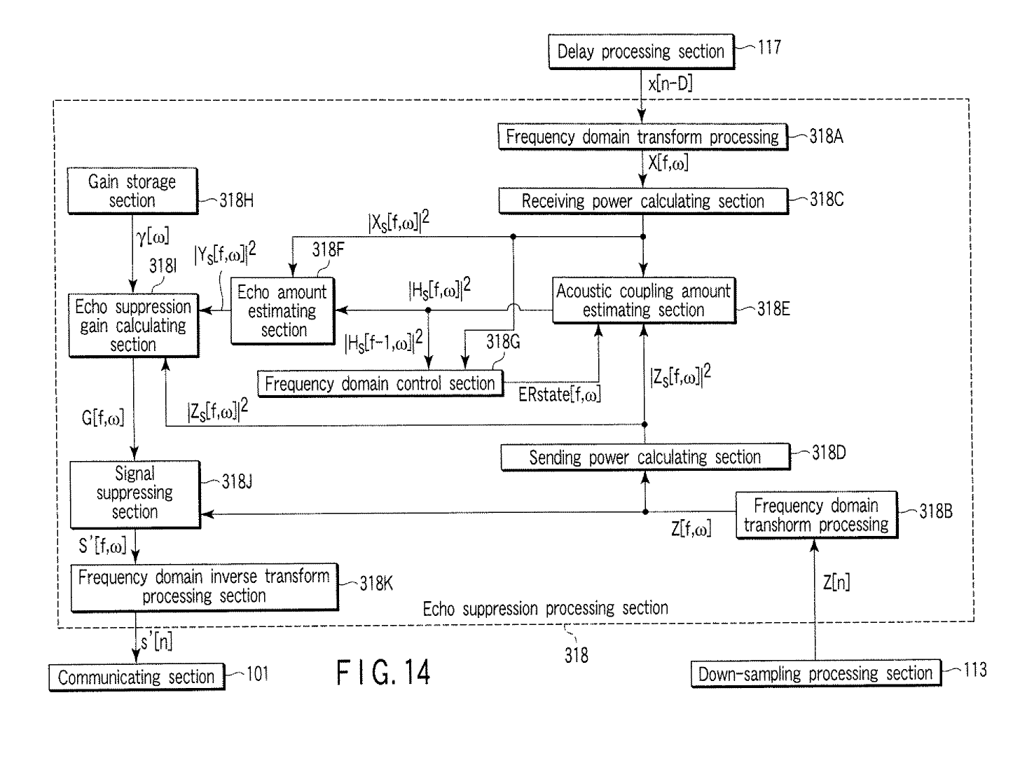

Next, the configuration of the echo suppression processing section 318 of the signal processing section shown in FIG. 13 is explained with reference to FIG. 14. FIG. 14 is a block diagram showing the configuration of the echo suppression processing section according to the third embodiment of this invention.

FIG. 14 is a block diagram showing the configuration of the echo suppression processing section 318. The echo suppression processing section 318 includes a frequency domain transform processing section 318A connected to a delay processing section 117, a frequency domain transform processing section 318B connected to a down-sampling processing section 113, received power calculating section 318C, sending power calculating section 318D, acoustic coupling amount estimating section 318E, echo amount estimating section 318F, frequency domain control section 318G, gain storage section 318H, echo suppression gain calculating section 318I, signal suppressing section 318J and a frequency domain inverse transform processing section 318K connected to a communicating section 101.

The echo suppression processing section 318 receives the received input signal x[n-D] delayed by and output from the delay processing section 117 and the sending input signal z[n] output from the down-sampling processing section 113, suppresses the echo component in the sending input signal z[n] and outputs a signal obtained after the echo suppression as a sending output signal s′[n] (n=0, 1, . . . , N−1) for each frame (for every N samples).

The frequency domain transform processing section 318A receives the delayed received input signal x[n-D] output from the delay processing section 117, transforms the signal into a frequency domain by a process such as an FFT (Fast Fourier Transform) process, and calculates and outputs a frequency spectrum X[f, ω] of the received input signal.

The frequency domain transform processing section 318B transforms the sending input signal z[n] output from the down-sampling processing section 113 into a frequency domain by the FET process or the like and calculates and outputs a frequency spectrum Z[f, ω] of the sending input signal.

The frequency domain transform processing section 318A and frequency domain transform processing section 318B adequately perform a windowing process using a Hamming window, use the past samples, and perform a zero-padding process or perform an overlap process. For example, signals of the number of FFT points are extracted from the past one frame and the present frame, the windowing process using a Hamming window is performed and the FFT process is performed.

The received power calculating section 318C receives the frequency spectrum X[f, ω] of the received input signal output from the frequency domain transform processing section 318A and calculates and outputs a receiving power spectrum |X[f, ω]|² which is the power spectrum thereof. Then, the receiving power calculating section 318C calculates and outputs a receiving power spectrum |X_{S}[f, ω]|² which is smoothed by use of the value |X_{S}[f-1, ω]|² of the immediately preceding frame.

The sending power calculating section 318D receives the frequency spectrum Z[f, ω] of the sending input signal output from the frequency domain transform processing section 318B and calculates and outputs a sending power spectrum |Z[f, ω]|² which is the power spectrum thereof. Then, the sending power calculating section 318D calculates and outputs a sending power spectrum |Z_{S}[f, ω]|² which is smoothed by use of the value |Z_{S}[f-1, ω]|² of the immediately preceding frame.

The acoustic coupling amount estimating section 318E receives the receiving power spectrum |X_{S}[f, ω]|² smoothed by and output from the receiving power calculating section 318C, the sending power spectrum |Z_{S}[f, ω]|² smoothed by and output from the sending power calculating section 31SD and frequency domain double-talk information ERstate[f, ω] output from the frequency domain control section 318G. Then, it calculates an acoustic coupling amount |H[f, ω]|² for each frequency band ω by using |Z_{S}[f, ω]|² based on the sending input signal. In the frequency band ω in which the frequency domain double-talk information ERstate[f, ω] does not indicate the double-talk state, |H[f, ω]|² is updated as |Z_{S}[f, ω]|²/|X_{S}[f, ω]|². In the frequency band ω in which the frequency domain double-talk information ERstate[f, ω] indicates the double-talk state, the value |H[f-1, ω]|² of the immediately preceding frame is maintained. Then, the acoustic coupling amount estimating section 318E outputs the acoustic coupling amount |H[f, ω]|² to the echo amount estimating section 318F.

The echo amount estimating section 318F receives the smoothed receiving power spectrum |X_{S}[f, ω]|² output from the receiving power calculating section 318S and the acoustic coupling amount |H[f, ω]|² output from the acoustic coupling amount estimating section 318E. Then, it outputs an echo amount |Y[f, ω]|² contained in the frequency spectrum Z[f, ω] of the sending input signal as |H[f, ω]|²×|X_{S}[f, ω]|² for each frequency band ω.

Then, the echo amount estimating section 318F calculates and outputs an echo amount |Y_{S}[f, ω]|² smoothed by use of a value in the immediately preceding frame for each frequency band ω.

The frequency domain control section 318G receives the smoothed receiving power spectrum |X_{S}[f, ω]|² output from the receiving power calculating section 318C and the acoustic coupling amount |H[f-1, ω]|² of the immediately preceding frame output from the acoustic coupling amount estimating section 318E and outputs frequency domain double-talk information ERstate[f, ω], which is information indicating whether the double-talk state is set or not.

If the acoustic coupling amount is rapidly changed, that is, if the relation of |H[f, ω]|²>β_{H}[ω]·|H[f-1, ω]|² is satisfied and when the received input signal is sufficiently large, that is, when the relation of |X_{S}[f, ω]²<β_{X}[ω] is satisfied, the frequency domain control section 318G sets the frequency domain double-talk information ERstate[f, ω] to the double-talk state. If not, it does not set the frequency domain double-talk information ERstate[f, ω] to the double-talk state.

Of course, an echo suppression processing section 318 having no frequency domain control section 318G can be used. In this case, the acoustic coupling amount estimating section 318E performs the operation when the frequency domain double-talk information ERstate[f, ω] indicates that the double-talk state is not set.

The gain storage section 318H stores and outputs a parameter γ[ω] used to control the previously set nonlinear echo suppression amount. In this case, it is preferable to set ω[ω] in the range of approximately 1.0 to 2.0.

The echo suppression gain calculating section 318I receives the smoothed sending power spectrum |Z_{S}[f, ω]|² output from the sending power calculating section 318D, the smoothed echo amount |Y_{S}[f, ω]|² output from the echo amount estimating section 318F and the parameter γ[ω] output from the gain storage section 318H and calculates and outputs an echo suppression gain G[f, ω] according to the following equation (1)

$$G [ f , ω ] = \frac{{\vert {Z}_{S} [ f , ω ] \vert}^{2} - γ ( ω ) \cdot \vert {{Y}_{S} [ f , ω ]}^{2} \vert}{{\vert {Z}_{S} [ f , ω ] \vert}^{2}} \qquad ( 1 )$$

Further, the echo suppression gain calculating section 318I controls the echo suppression gain G[f, ω] to be set in the range of 0 to 1 in order to prevent the quality of the sending speech from being degraded due to excessive echo suppression.

The signal suppressing section 318J receives the frequency spectrum Z[n, ω] of the sending input signal output from the frequency domain transform processing section 318B and the echo suppression gain G[n, ω] output from the echo suppression gain calculating section 318I. Then, it suppresses an echo of the frequency spectrum Z[n, ω] of the sending input signal output from the frequency domain transform processing section 318B and outputs the thus obtained spectrum as a spectrum S′[f, ω] of the sending output signal. Specifically, an amplitude spectrum |S′[f, ω]| of the sending output signal is derived by the product of an amplitude spectrum |Z[n, ω]| of the sending input signal and the echo suppression gain G[n, ω]. In this case, it is supposed that the phase spectrum of the sending output signal is the same as the phase spectrum of the sending input signal.

The frequency domain inverse transform processing section 318K receives the frequency spectrum S′[f, ω] output from the signal suppressing section 318J and calculates and outputs a sending output signal s′[n] (n=0, 1, . . . , N'1) by an IFFT (Inverse Fast Fourier Transform) process or the like. At this time, a process of restoring the overlap state is adequately performed by use of the past samples s′[n] by considering the windowing or the zero-padding process of the frequency domain transform processing section 318A and frequency domain transform processing section 318.

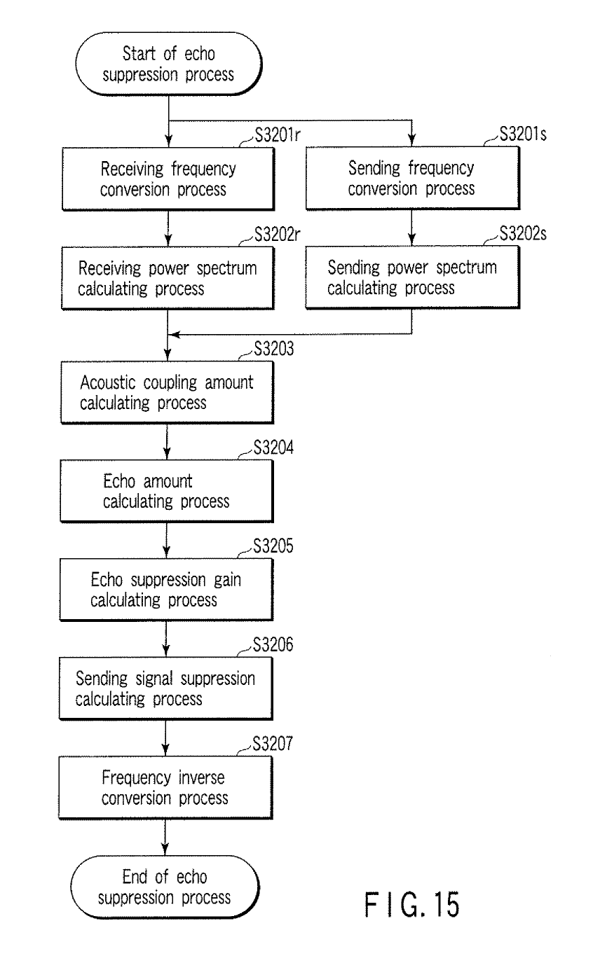

The flow of the process of the echo suppression processing section 318 shown in FIG. 14 is explained with reference to the flowchart of FIG. 15. The frequency domain transform processing section 318A transforms the delayed received input signal x[n-D] into a frequency domain and calculates a frequency spectrum X[f, ω] of the received input signal (step S3201r). Further, the receiving power calculating section 318C calculates a receiving power spectrum |X[f, ω]|² and smoothed receiving power spectrum |X_{S}[f, ω]|² (step S3202r).

Likewise, the frequency domain transform processing section 318B transforms the sending input signal z[n] into a frequency domain and calculates a frequency spectrum Z[f, ω] of the sending input signal (step S3201s). Further, the sending power calculating section 318D calculates a sending power spectrum |Z[f, ω]|² and smoothed sending power spectrum |Z_{S}[f, ω]|² (step S3202s).

Then, the frequency domain control section 318G outputs frequency domain double-talk information ERstate[f, ω], and the acoustic coupling amount estimating section 318E receives the smoothed receiving power spectrum |X_{S}[f, ω]|², smoothed sending power spectrum |Z_{S}[f, ω]|² and frequency domain double-talk information ERstate[f, ω] and calculates an acoustic coupling amount |H[f, ω]|² (step S3203). The echo amount estimating section 318F receives the acoustic coupling amount |H[f, ω]|² and smoothed receiving power spectrum |X_{S}[f, ω]|², and estimates an echo amount |Y_{S}[f, ω]|² contained in the sending input signal (step S3204).

The echo suppression gain calculating section 318I receives the smoothed sending power spectrum |Z_{S}[f, ω]|² output from the sending power calculating section 318D, the smoothed echo amount |Y_{S}[f, ω]|² output from the echo amount estimating section 318F and the parameter γ[ω] output from the gain storage section 318H and calculates an echo suppression gain G[f, ω]. Further, the echo suppression gain calculating section 318I controls the echo suppression gain G[f, ω] to be set in the range of 0 to 1 (step S3205).

Then, the signal suppressing section 318J receives the echo suppression gain G[f, ω] calculated in the echo suppression gain calculating section 318I and suppresses an echo (step S3206) Finally, the frequency domain inverse transform processing section 318K subjects the frequency spectrum S′[f, ω] output from the signal suppressing section 318J to the frequency domain inverse transform process (step S3207) and then the echo suppression process is terminated.

As the example of the echo suppression process in the present embodiments, the adaptive filter, frequency domain adaptive filter, and frequency domain echo suppression process (echo reduction) are sequentially explained, but each embodiment can be realized by changing the above echo suppression processes or adequately combining them without departing from the technical scope of this invention.

Further, in the above embodiments, the process of suppressing an echo contained in the sending output signal such as the process of adding the delay detection signal and detecting the delay amount of the delay detection signal is wholly realized by use of the computer program. Therefore, the same effect as that of the present embodiment can be easily attained simply by installing the computer program into a normal computer via a storage medium which can be read by the computer. Further, the computer program can be executed by use of not only the personal computer but also various types of electronic devices each containing a processor.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A signal processing apparatus comprising:
a received signal input section configured to receive a received input signal:
a delay detection signal generating section configured to generate a delay detection signal which has a frequency component of an inaudible frequency;
a superposition processing section configured to superpose the delay detection signal on the received input signal;
a speaker configured to output the received input signal on which the delay detection signal is superposed to an acoustic space;
a microphone configured to collect sound in the acoustic space and output a sending input signal;
an extracting section configured to extract the delay detection signal from the sending input signal;
a calculating section configured to calculate a delay time between the received input signal and an acoustic echo component contained in the sending input signal caused by the received input signal supplied through the acoustic space based on a delay detection signal output from the delay detection signal generating section and the extracted delay detection signal;
a delay section configured to delay the received input signal by a time corresponding to the delay time and generate a delayed received input signal; and
an echo suppression processing section configured to suppress the acoustic echo component contained in the sending input signal by use of the delayed received input signal.

2. The signal processing apparatus according to claim 1, in which the received input signal has a first frequency as a sampling frequency and the sending input signal has a second frequency higher than the first frequency as a sampling frequency and which further comprises a converting section configured to convert the sampling frequency of the sending input signal to the first frequency and output the sending input signal of the converted frequency to the echo suppression processing section, and a correction processing section configured to perform a correction process for the delay time according to the first frequency.

3. The signal processing apparatus according to claim 1, wherein the delay detection signal generating section intermittently generates the delay detection signal of a frequency component on a high-frequency band side of the inaudible frequency bands and generates the delay detection signal to cause a continuous generation frequency of the delay detection signal to be set to a frequency band on a low-frequency band side of the inaudible frequency bands.

4. The signal processing apparatus according to claim 1, wherein the delay detection signal generating section intermittently generates the delay detection signal of a frequency component on a high-frequency band side of the inaudible frequency bands and generates the delay detection signal to cause continuous frequency components of the delay detection signal to be made different.

5. The signal processing apparatus according to claim 1, further comprising a volume calculating section configured to calculate a volume of the extracted delay detection signal, and a volume control section configured to control a volume of the delay detection signal according to the calculated volume.

6. The signal processing apparatus according to claim 1, further comprising a control section configured to acquire a system resource and control timing at which the delay detection signal is generated according to the acquired system resource.

7. The signal processing apparatus according to claim 1, wherein the delay detection signal generating section generates the delay detection signal with a frequency component in an inaudible frequency according to age information of a user.

8. A program which is stored in a computer readable media and cause a computer to perform suppressing echo contained in a sending input signal, comprising:
causing the computer to perform a process of generating a delay detection signal of a frequency component in an inaudible frequency according to a control signal;
causing the computer to perform a process of superposing the delay detection signal on a received input signal;
causing the computer to perform a process of outputting the received input signal on which the delay detection signal is superposed from a speaker to an acoustic space;
causing the computer to perform a process of collecting sounds in the acoustic space and outputting a sending input signal from a microphone;
causing the computer to perform a process of extracting the delay detection signal from the sending input signal;
causing the computer to perform a process of calculating a delay time between the received input signal and an acoustic echo component contained in the sending input signal caused by the received input signal supplied through the acoustic space based on a delay detection signal superposed on the received input signal and the extracted delay detection signal;
causing the computer to perform a process of delaying the received input signal by a time corresponding to the delay time and generating a delayed received input signal; and
causing the computer to perform a process of suppressing the acoustic echo component contained in the sending input signal by use of the delayed received input signal.

9. The program according to claim 8, wherein the received input signal has a first frequency as a sampling frequency, and the sending input signal has a second frequency higher than the first frequency as a sampling frequency and
the program further comprises causing the computer to perform a process of converting the sampling frequency of the sending input signal to the first frequency, and causing the computer to perform a process of correcting the delay time according to the first frequency.

10. The program according to claim 8, wherein the delay detection signal of a frequency component on a high-frequency band side of the inaudible frequency bands is intermittently generated and the delay detection signal is generated to cause a continuous generation frequency of the delay detection signal to be set to a frequency band on a low-frequency band side of the inaudible frequency bands.

11. The program according to claim 8, wherein the delay detection signal of a frequency component on a high-frequency band side of the inaudible frequency bands is intermittently generated and the delay detection signal is generated to cause continuous frequency components of the delay detection signal to be made different.

12. The program according to claim 8, further comprising causing the computer to perform a process of calculating a volume of the extracted delay detection signal, and causing the computer to perform a process of controlling a volume of the delay detection signal according to the calculated volume.

13. The program according to claim 8, further comprising causing the computer to perform a process of acquiring a system resource and causing the computer to perform a process of controlling the timing at which the delay detection signal is generated according to the acquired system resource.

14. The program according to claim 8, further comprising causing the computer to perform a process of generating the delay detection signal with a frequency component in an inaudible frequency according to age information of a user.
